(19) United States
(12) Patent Application Publication
(10) Pub. No.: US 2008/0189273 A1
(43) Pub. Date: Aug. 7, 2008

(54) SYSTEM AND METHOD FOR UTILIZING ADVANCED SEARCH AND HIGHLIGHTING TECHNIQUES FOR ISOLATING SUBSETS OF RELEVANT CONTENT DATA

(75) Inventors: Andrew P. Kraftsow, Sedona, AZ (US); Ray Lugo, Old Bridge, NJ (US)

Correspondence Address: BERRY & ASSOCIATES P.C., 9255 SUNSET BOULEVARD, SUITE 810, LOS ANGELES, CA, 90069, US

(73) Assignee: DIGITAL MANDATE, LLC, New York, NY (US)

(21) Appl. No.: 12/025,715

(22) Filed: Feb. 4, 2008

Related U.S. Application Data
(63) Continuation-in-part of application No. 11/449,400, filed on Jun. 7, 2006.

(51) Int. Cl. G06F 7/00

(52) U.S. Cl. 707/5

(57) ABSTRACT

A system and methods for utilizing advanced automated search techniques including highlighting capability for determining subsets of relevant content data (in paper or electronic form) is disclosed. These techniques are advantageous in reviewing vast collections of content data or documents to identify relevant data or documents from the collections. The advanced search techniques are based on query terms, which isolate relevant content data that respond to the query terms. A probability of relevancy can be determined for a unit of content data or document in the returned subset to facilitate exclusion of a document from the subset if it does not reach a threshold probability of relevancy. Documents in a thread of a correspondence (for example, an e-mail) in the responsive documents subset can be added to the responsive documents subset. Further, an attachment to a document in the responsive documents subset can be added to the responsive documents subset. A statistical technique is applied to determine whether remaining documents in the collection meet a predetermined acceptance level.

### PRIORITY CLAIM

This application is a continuation-in-part application of U.S. patent application Ser. No. 11/449,400 filed on Jun. 7, 2006, and entitled “Methods for Enhancing Efficiency and Cost Effectiveness of First Pass Review of Documents”, the contents of which are incorporated herein by reference and are relied upon here.

### FIELD OF THE INVENTION

The present invention relates to systems and methods involving techniques for review and analysis of content data (in paper or electronic form) such as a collection of documents. It should be understood that paper form must be converted and represented in electronic form (e.g., by well-known optical character recognition (OCR) techniques for capturing paper and portable document format (PDF created by Adobe Systems) form that is searchable). More particularly, the present invention relates to a system and method for utilizing advanced organizing, searching, tagging, and highlighting techniques for identifying and isolating relevant data with a high degree of confidence¹ or certainty from large quantities of content data. ¹ Definition of Confidence Level per the US Department of Justice: “The level of certainty to which an estimate can be trusted.” www.ojp.usdoj.gov/BJA/evaluation/glossary/glossary_c.htm

### BACKGROUND

In the current age of information, management of content data (e.g. documents in electronic or paper form) is a daunting task. Analysis of large amounts of content data is necessary in business for many purposes, for example, litigation, regulatory activities, due diligence studies, compliance management, investigations etc. For example, just in the context of a litigation proceeding in the United States, document discovery is an enormous endeavor and results in large expenses because documents must be carefully reviewed by skilled and talented legal personnel. This expensive exercise is undertaken both not only by the party seeking the discovery, but also by the party producing documents in response to document requests by the former.

Although review and analysis of data must still today be performed by skilled legal personnel, any efforts to automate this process of reviewing and organizing content data results in great savings. However, the automated methods that do exist today are largely unsophisticated and often yield results that are not entirely accurate. For example, the conventional methods of conducting discovery today first involve gathering up every document written or received by the named individuals during a designated time period and then having skilled legal personnel review these documents to determine if any is responsive to a specific discovery request. This approach is not only prohibitively expensive, but also time consuming. Not to mention that the burden of pursuing such conventional approaches is increasing with the increasing volumes of data that is compiled in this age of information.

In some cases, search engine technology is used to make the document review process more manageable. However, the quality and completeness of search results resulting from such conventional search engine techniques are often indefinite and therefore, unreliable. For example, one does not know whether the search engine used has indeed found every relevant document, at least not with any certainty.

The main search engine technique currently used is a keyword or a free-text search coupled with indexing of terms in the documents. A user enters a search query consisting of one or more words or phrases and the search system uncovers all of the documents that have been indexed as having one or more those words or phrases in the search query. As the search system indexes more documents that contain the specified search terms, they are revealed to the user. However, in many cases, such a search technique only marginally reduces the number of documents to be reviewed, and the large quantities of documents returned cannot be usefully examined by the user. There is absolutely no guarantee that the desired information is contained in any of the documents that are uncovered.

Furthermore, many of the documents retrieved in a standard search are typically irrelevant because these documents use the searched-for terms in a way or context different from that intended by the user. Words have multiple meanings. One dictionary, for example, lists more than 50 definitions for the word “pitch.” In ordinary usage by skilled humans, such ambiguities are not a significant problem because skilled humans effortlessly know the appropriate word for any situation. In addition, conventional search engine techniques often miss relevant content data because the missed documents do not include the search terms but rather include synonyms of the search terms. That is, the search technique fails to recognize that different words can almost mean the same thing. For example, “elderly,” “aged,” “retired,” “senior citizens,” “old people,” “golden-agers,” and other terms are used, to refer to the same group of people. A search based on only one of these terms would fail to return a document if the document used a synonym rather than the search term. Some search engines allow the user to use Boolean operators. Users could solve some of the above-mentioned problems by including enough terms in a query to disambiguate its meaning or to include the possible synonyms that might be used, but clearly this takes considerable effort.

However, unlike the familiar internet searches, where a user is primarily concerned with finding any document that contains the precise information the user is seeking, discovery in a litigation is about finding every document that contains information relevant to the subject. An internet search requires a high degree of precision, whereas the discovery process requires not only a high degree of precision, but also high recall.

Continuing with the example of discovery in litigation, search queries are typically developed with the object of finding every relevant document regardless of the specific nomenclature used in the document. This makes it necessary to develop lists of synonyms and phrases that encompass every imaginable word usage combination. In practice, the total number of documents retrieved by these queries is very large.

Methodologies that rely exclusively on technology to determine which content data in a vast collection of data is relevant to a lawsuit have not gained wide acceptance regardless of the technology used. These methodologies are often deemed unacceptable because the algorithms used by the systems to determine relevancy are incomprehensible to most parties to a law suit.

There is a dire need for improved techniques that facilitate efficient isolation of relevant content data with a high degree of certainty for purposes of reviewing and analyzing the relevant data. In addition, there is an ongoing need for improved searching, tagging, and highlighting techniques to ensure increased efficiency during such review and analysis.

### SUMMARY OF THE INVENTION

The present invention relates to a system and method for utilizing advanced searching, tagging, and highlighting techniques for identifying and isolating relevant data with a high degree of certainty from large quantities of content data (in paper or electronic form).

In accordance with one aspect, the system and methods of the present invention perform an advanced search of vast amounts of content data based on query terms, in order to retrieve a subset of responsive content data. In one exemplary embodiment, a probability of relevancy or degree of certainty is determined for a unit of content data or document in the returned subset, and the content data or document is removed from the subset if it does not reach a threshold probability of relevancy. A statistical technique can be applied to determine whether remaining documents (that is, not in the responsive documents subset) in the collection meet a predetermined acceptance level.

In accordance with yet another aspect of the invention, the system considers all content data in a thread of correspondence (for example, an e-mail) and includes it in the subset of relevant data. The system also scans the content data in the thread and automatically identifies other data of interest, for example, contained in attachments and includes that as well.

In accordance with still another aspect of the invention, the system assures greater efficiency, by taking the following steps: (a) randomly selecting a predetermined number of documents from remaining content data; (b) reviewing the randomly selected documents to determine whether the randomly selected documents include additional relevant documents; (c) if additional relevant documents are retrieved, identifying one or more specific terms in the additional content data that renders the data relevant and expanding the query terms with those specific terms, and running the search again with the expanded query terms.

In yet a further aspect of the system and methods described here, a feedback loop criteria, ensures that content data that is relevant with a high degree of certainty and probability is shown early on to human reviewers. In traditional content data review, content data that is isolated and queued up for consideration is usually ordered by custodian and chronology. Even if some other method is used, the order generally remains fixed throughout the isolating process. To accomplish this, the system and methods here use a heuristic algorithm for selecting the next content data unit or document that takes into account the disposition of the content data or documents previously seen by the reviewers. The algorithm operates in both an inclusive and an exclusive direction. Content data and documents are excluded from the isolating process if they contain any previously seen relevant language strings. To effect this, the database must be continuously updated during the isolating process to reflect the strings that human reviewers may discover. The system described here permits modification of search routines based on human input of attributes contained in content data found to be relevant. Hence, content data in a queue for consideration may be moved up. For example, attributes such as author, date, subject (if email), size, document type and social network may be used.

In yet a further aspect of the invention, instead of finding all content data relevant to an issue and with a high degree of certainty, the system can search and isolate certain key content data of particular interest (e.g. “privileged” or “hot” documents). The system and methods described here accomplish this with two steps: 1) a re-evaluation of the database unitization and 2) a recalculation of the Poisson distribution² criteria. Poisson distribution criteria demands that the relevance of object A has no impact on the relevance of object B. To isolate “hot” data content, the system considers not only the text but also the author and recipient of the text. Therefore, the system searches for privileged or “hot” documents. The system has to remove duplicate documents at a different level and then has to recalculate the formulas based on the expected density of the subject matter that is being search to determine sample size. To isolate select privileged data, the system uses precise and rigorous string identifications such as the topic in conjunction with noun, verb, or object sets. ² In probability theory and statistics, the Poisson distribution is a discrete probability distribution that expresses the probability of a number of events occurring in a fixed period of time if these events occur with a known average rate and independently of the time since the last event.

In accordance with an entirely automated aspect of the system, without human operators, the system incorporates an automatic query-builder. With this aspect human operators simply highlight the parts of the content data or document that seem relevant to an issue(s) and the software components of the system automatically formulate precise boolean queries utilizing the highlighted parts of the text. The highlighted text need not be contiguous. To construct the query, the system runs the highlighted text through a part-of-speech tagger, which eliminates various parts of speech and eliminates stop-words. The system executes some rules about the operator “within” and then builds the query. The automatic query builder aspect of the system also permits expert users to make some “AND” or “OR” decisions about non-contiguous highlights by holding down the CONTROL key while executing the highlighting function. This automatic query builder significantly reduces the need for human operators. In accordance with this aspect, users read the document, highlighting whatever language strings relate to the issues that they seek to address. The user associates each highlighted text to an issue (or multiple issues). When the users are done with this exercise, the automated query builder forms the queries, runs them in the background and bulk tags the search result documents. The system also displays a sample of randomly selected results so that the user can test the statistical certainty that the query was precise.

### BRIEF DESCRIPTION OF THE DRAWINGS

The features of the present application can be more readily understood from the following detailed description with reference to the accompanying drawings wherein:

FIG. 1 is a block diagram of a computer system or information terminal on which programs can run to implement the methods of these inventions described here.

FIG. 2 is a flow chart of an exemplary method of reviewing vast collections of content data to identify relevant content data.

FIG. 3 is a flow chart of an exemplary method for reviewing vast collections of content data to identify relevant content data.

FIG. 4 is a flow chart of a method for reviewing a collection of content data or documents to identify relevant documents from the collection, according to another exemplary embodiment.

FIG. 5 is a flow chart of a method for reviewing a collection of content data or documents to identify relevant documents from the collection, according to another exemplary embodiment.

FIG. 6 is a flow chart of a method for reviewing a collection of content data or documents to identify relevant documents from the collection, according to another exemplary embodiment.

FIGS. 7A and 7B represent a flow chart for a workflow of a process including application of some of the techniques discussed here.

FIG. 8 is a flow chart of an automated query builder feature of the present system and method.

FIG. 9 is a flow chart of an example illustrating a database containing emails, attachments, and stand alone files from a corporate network, all which constitute the content data for review.

FIG. 10 is a flow chart of an exemplary embodiment of a “smart highlighter” feature of the present system and method.

### DETAILED DESCRIPTION

Non-limiting details of exemplary embodiments are described below, including discussions of theory and experimental simulations which are set forth to aid in an understanding of this disclosure but are not intended to, and should not be construed to limit in any way the claims which follow thereafter.

The present invention relates to systems and methods involving techniques for organization, review and analysis of content data (in paper or electronic form), such as a collection of documents. The systems and methods described here utilize advanced searching, tagging, and highlighting techniques for identifying and isolating relevant content data with a high degree of confidence³ or certainty from large quantities of content data. ³ Definition of Confidence Level per the US Department of Justice: “The level of certainty to which an estimate can be trusted.” www.ojp.usdoj.gov/BJA/evaluation/glossary/glossary_c.htm

The system search techniques used here search the content data based on language “strings.” In addition, the system uses Poisson-based mathematics to predict how much content data or how many documents would need to be reviewed before finding every relevant language string in the collection of content data. This is based on the principle that relevant language strings are distributed in content data in accordance with the theory of Poisson distribution. Moreover, the number of relevant strings in a given amount of content data or document is a function of the number of issues addressed, not a function of the size of the content data. Furthermore, the number of relevant language strings, on average, does not exceed 50 per issue regardless of the size of the collection of content data. Because the system uses Poisson-based mathematics, the system retrieves content data with relevant language strings quickly and efficiently, thereby saving unnecessary review of irrelevant data by skilled humans. Review of irrelevant data without use of this system was inevitable because the data presented was organized by custodian and chronology.

The system and techniques here additionally use Poisson-based statistical sampling to prove that isolation of relevant content data is accomplished with a stated degree of certainty. In other words, that all content data with relevant language strings is retrieved. The system uses a defined set of rules and a Boolean search engine to find every occurrence of relevant language strings. By using a bulk tagging mechanism, and applying specific tagging rules and naming conventions, the system marks the relevant documents in a manner that is auditable. This way of tagging yields two benefits—1) a user knows exactly why each document was tagged as relevant; and 2) a user can “undo” the tagging if a language string is re-classified as non-relevant at a later date.

In some instances, documents are delivered to an assembly line of skilled humans to review documents in batches (the most common situation). Identifying relevant language strings in prior batches significantly decreases the time to review documents in future batches.

Full citations for a number of publications may be found immediately preceding the claims. The disclosures of these publications are hereby incorporated by reference into this application in order to more fully describe the state of the art as of the date of the methods and apparatuses described and claimed herein. In order to facilitate an understanding of the discussion which follows one may refer to the publications for certain frequently occurring terms which are used herein.

Although not required, the invention will be described in the general context of computer-executable instructions, such as program modules. Generally, program modules include routines, programs, objects, scripts, components, data structures, etc. that performs particular tasks or implement particular abstract data types. Moreover, those skilled in the art will appreciate that the invention may be practiced with any number of computer system configurations including, but not limited to, distributed computing environments where tasks are performed by remote processing devices that are linked through a communications network. In a distributed computing environment, program modules may be located in both local and remote memory storage devices. The present invention may also be practiced in personal computers (PCs), hand-held devices, multiprocessor systems, microprocessor-based or programmable consumer electronics, network PCs, minicomputers, mainframe computers, and the like.

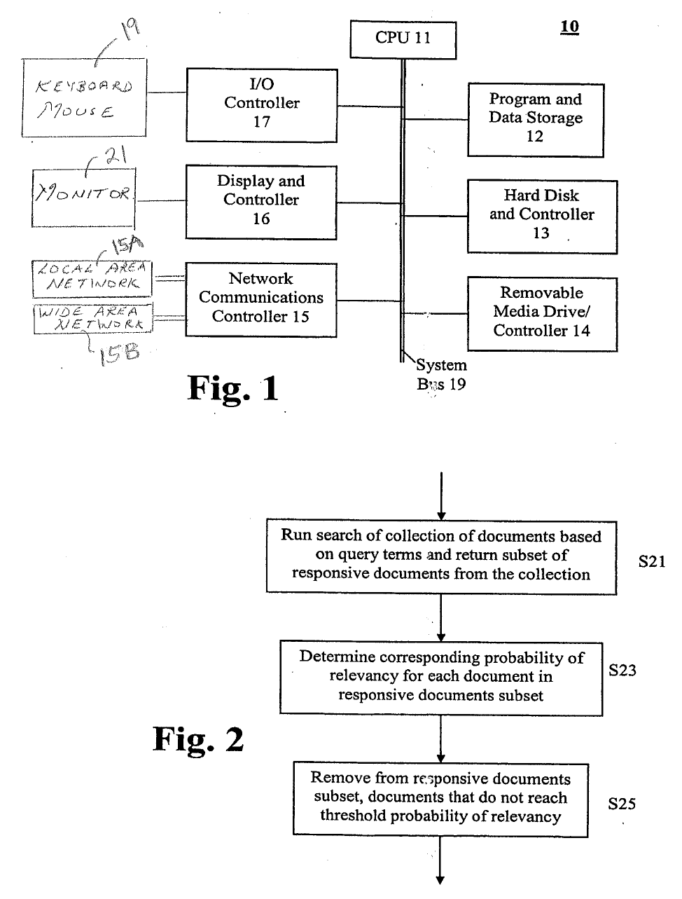

FIG. 1 is a schematic diagram of an exemplary computing environment in which the present invention may be implemented. The present invention may be implemented within a general purpose computing device 10 in the form of a conventional computing system. One or more computer programs may be included in the implementation of the system and method described in this application. The computer programs may be stored in a machine-readable program storage device or medium and/or transmitted via a computer network or other transmission medium.

Computer 10 includes CPU 11, program and data storage 12, hard disk (and controller) 13, removable media drive (and controller) 14, network communications controller 15 (for communications through a wired or wireless network (LAN or WAN, see 15A and 15B), display (and controller) 16 and I/O controller 17, all of which are connected through system bus 19. Although the exemplary environment described herein employs a hard disk (e.g. a removable magnetic disk or a removable optical disk), it should be appreciated by those skilled in the art that other types of computer readable media which can store data that is accessible by a computer, such as magnetic cassettes, flash memory cards, digital video disks, Bernoulli cartridges, random access memories (Rams), read only memories (ROMs), and the like, may also be used in the exemplary operating environment.

A number of program modules may be stored on the hard disk 13, magnetic disk, and optical disk, ROM or RAM, including an operating system, one or more application programs, other program modules, and program data. A user may enter commands and information into the computing system 10 through input devices such as a keyboard (shown at 19), mouse (shown 19) and pointing devices. Other input devices (not shown) may include a microphone, joystick, game pad, satellite dish, scanner, or the like. These and other input devices are often connected to the central processing unit 11 through a serial port interface that is coupled to the system bus, but may be connected by other interfaces, such as a parallel port, game port or a universal serial bus (USB). A monitor 21 or other type of display device is also connected to the system bus via an interface, such as a video adapter. In addition to the monitor 21, computers typically include other peripheral output devices (not shown), such as speakers and printers. The program modules may be practiced using any computer languages including C, C++, assembly language, and the like.

Some examples of the methods implemented for reviewing a collection of content data or documents to identify relevant documents from the collection in accordance with exemplary embodiments of the present invention are described below.

In one example (FIG. 2), a method for reviewing a content data or a vast collection of documents to identify relevant documents from the collection can entail a) running a search of the collection of documents based on a plurality of query terms and b) retrieving a subset of responsive documents from the collection (step S21), 3) determining a corresponding probability of relevancy for each document in the responsive documents subset (step S23) and 4) removing from the responsive documents subset, documents that do not reach a threshold probability of relevancy (step S25).

The search techniques discussed in this disclosure are preferably automated as much as possible. Therefore, the search is preferably applied through a search engine. The search can include a concept search, and the concept search is applied through a concept search engine. Such searches and other automated steps or actions can be coordinated through appropriate programming, as would be appreciated by one skilled in the art.

The probability of relevancy of a document can be scaled according to a measure of obscurity of the search terms found in the document. The method can further comprise a) randomly selecting a predetermined amount of content data or a sample number of documents from the remaining content data found to be not relevant. and b) determining whether the randomly selected documents include additional relevant documents, and in addition, optionally, identifying one or more specific terms in the additional relevant documents that render the documents relevant, expanding the query terms with the specific terms, and re-running at least the search with the expanded query terms. In the event the randomly selected content data or documents include one or more additional relevant items of content data, the query terms can be expanded and the search run again with the expanded query terms. The method additionally comprises comparing a ratio of the additional relevant documents and the randomly selected documents to a predetermined acceptance level, to determine whether to apply a refined set of query terms.

The method further comprises the step of selecting two or more search terms, identifying synonyms of the search terms, and forming the query terms based on the search terms and synonyms.

The method further comprises the step of identifying a correspondence between a sender and a recipient, in the responsive documents subset, automatically determining one or more additional documents which are in a thread of the correspondence, the additional documents not being in the responsive documents subset, and adding the additional documents to the responsive documents subset. The term “correspondence” is used herein to refer to a written or electronic communication (for example, letter, memo, e-mail, text message, etc.) between a sender and a recipient, and optionally with copies going to one or more copy recipients.

The method further comprises the step of determining whether any of the documents in the responsive documents subset includes an attachment that is not in the responsive documents subset, and adding the attachment to the responsive documents subset. The method further comprises the step of applying a statistical technique (for example, zero-defect testing) to determine whether remaining documents not in the responsive documents set meet a predetermined acceptance level.

In one embodiment, the search includes (a) a Boolean search of the collection of documents based on the plurality of query terms, the Boolean search returning a first subset of responsive documents from the collection, and (b) a second search by applying a recall query based on the plurality of query terms to remaining ones of the collection of documents which were not returned by the Boolean search, the second search returning a second subset of responsive documents in the collection, and wherein the responsive documents subset is constituted by the first and second subsets. The first Boolean search may apply a measurable precision query based on the plurality of query terms. The method can optionally further include automatically tagging each document in the first subset with a precision tag, reviewing the document bearing the precision tag to determine whether the document is properly tagged with the precision tag, and determining whether to narrow the precision query and rerun the Boolean search with the narrowed query terms. The method can optionally further comprise automatically tagging each document in the second subset with a recall tag, reviewing the document bearing the recall tag to determine whether the document is properly tagged with the recall tag, and determining whether to narrow the recall query and rerun the second search with the narrowed query terms. The method can optionally further include reviewing the first and second subsets to determine whether to modify the query terms and rerun the Boolean search and second search with modified query terms.

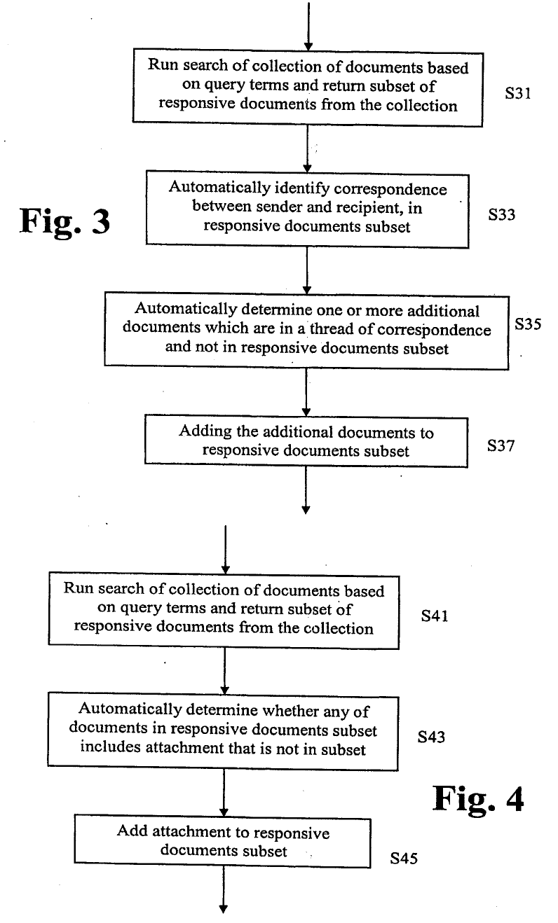

In another example (FIG. 3), a method for reviewing a collection of documents to identify relevant documents from the collection includes running a search of the collection of documents, based on a plurality of query terms, the search returning a subset of responsive documents in the collection (step S31), automatically identifying a correspondence between a sender and a recipient, in the responsive documents subset (step S33), automatically determining one or more additional documents which are in a thread of the correspondence, the additional documents not being in the responsive documents subset (step S35), and adding the additional documents to the responsive documents subset (step S37).

Some additional features which are optional include the following.

The method can further comprise determining for each document in the responsive documents subset, a corresponding probability of relevancy, and removing from the responsive documents subset documents that do not reach a threshold probability of relevancy. The probability of relevancy of a document can be scaled according to a measure of obscurity of the search terms found in the document.

The system and method further comprises applying a statistical technique to determine whether a remaining subset of the collection of documents not in the responsive documents subset meets a predetermined acceptance level.

The method additionally comprises the steps of a) randomly selecting a predetermined number of documents from a remainder of the collection of documents not in the responsive documents subset, b) determining whether the randomly selected documents include additional relevant documents, c) identifying one or more specific terms in the additional relevant documents that render the documents relevant, d) expanding the query terms with the specific terms, and e) running the search again with the expanded query terms.

The method further includes the steps of a) randomly selecting a predetermined number of content data or documents from a remainder of the collection of documents not in the responsive documents subset, b) determining whether the randomly selected documents include additional relevant documents, c) comparing a ratio of the additional relevant documents and the randomly selected documents to a predetermined acceptance level, and expanding the query terms and d) running the search with the expanded query terms, if the ratio does not meet the predetermined acceptance level.

The method further comprises the step of selecting two or more search terms, identifying synonyms of the search terms, and forming the query terms based on the search terms and synonyms.

The method additionally includes the step of determining whether any of the responsive content data or documents in the responsive documents subset includes an attachment that is not in the subset, and adding the attachment to the subset.

In another example (FIG. 4), a method for reviewing a collection of documents to identify relevant documents from the collection can comprise running a search of the collection of documents, based on a plurality of query terms, the search returning a subset of responsive documents in the collection (step S41), automatically determining whether any of the responsive documents in the responsive documents subset includes an attachment that is not in the subset (step S43), and adding the attachment to the responsive documents subset (step S45).

Some additional features which are optional include the following.

The method further comprises determining for each document in the responsive documents subset, a corresponding probability of relevancy, and removing from the responsive documents subset documents that do not reach a threshold probability of relevancy. The probability of relevancy of a document is preferably scaled according to a measure of obscurity of the search terms found in the document.

The method additionally comprises applying a statistical technique to determine whether a remaining subset of the collection of documents not in the responsive documents subset meets a predetermined acceptance level.

The method further includes randomly selecting a predetermined number of documents from a remainder of the collection of documents not in the responsive documents subset, determining whether the randomly selected documents include additional relevant documents, identifying one or more specific terms in the additional responsive documents that render the documents relevant, expanding the query terms with the specific terms, running the search again with the expanded query terms.

The method further includes selecting two or more search terms, identifying synonyms of the search terms, and forming the query terms based on the search terms and synonyms.

The method further comprises identifying a correspondence between a sender and a recipient, in the responsive documents subset, automatically determining one or more additional documents which are in a thread of the correspondence, the additional documents not being in the responsive documents subset, and adding the additional documents to the responsive documents subset.

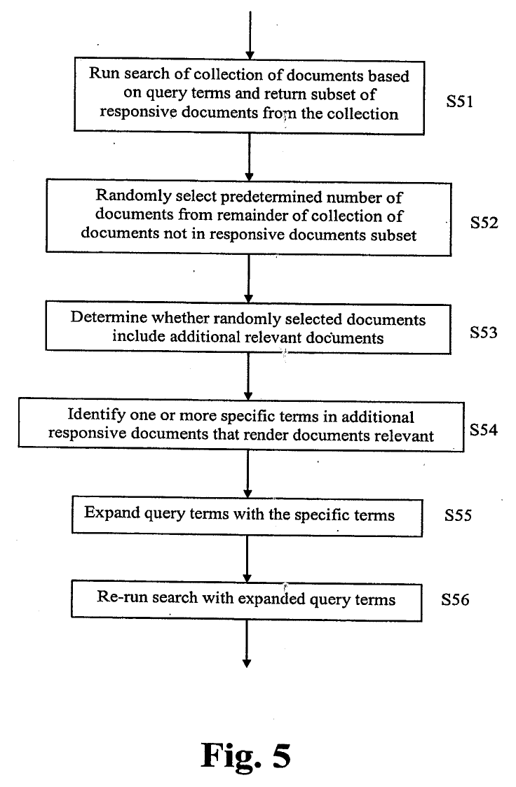

In another example (FIG. 5), a method for reviewing a collection of documents to identify relevant documents from the collection comprises running a search of the collection of documents, based on a plurality of query terms, the search returning a subset of responsive documents from the collection (step S51), randomly selecting a predetermined number of documents from a remainder of the collection of documents not in the responsive documents subset (step S52), determining whether the randomly selected documents include additional relevant documents (step S53), identifying one or more specific terms in the additional responsive documents that render the documents relevant (step S54), expanding the query terms with the specific terms (step S55), and re-running the search with the expanded query terms (step S56).

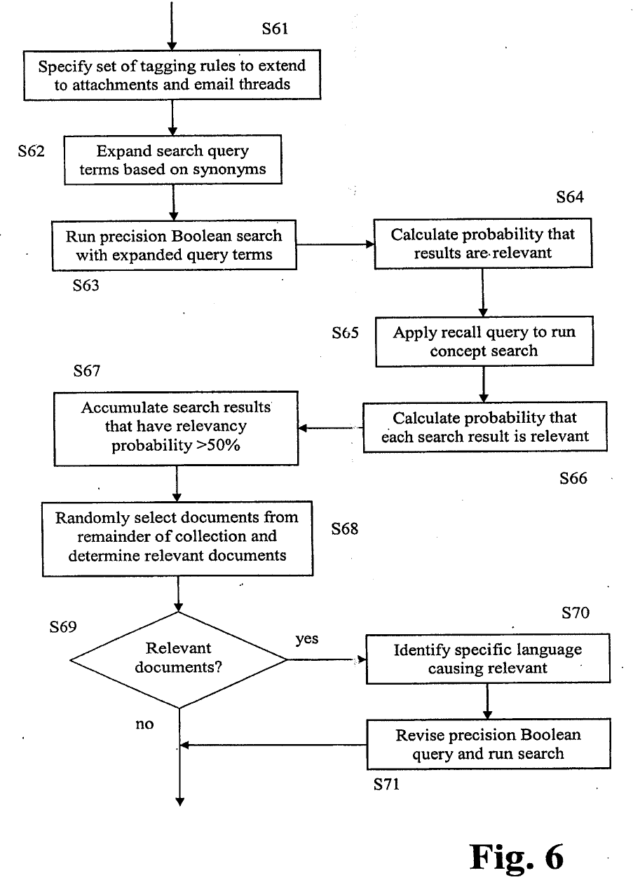

In another example (FIG. 6), a method for reviewing a collection of documents to identify relevant documents from the collection can comprise specifying a set of tagging rules to extend query results to include attachments and email threads (step S61), expanding search query terms based on synonyms (step S62), running a precision Boolean search of the collection of documents, based on two or more search terms and returning a first subset of potentially relevant documents in the collection (step S63), calculating the probability that the results of each Boolean query are relevant by multiplying the probability of relevancy of each search term, where those individual probabilities are determined using an algorithm constructed from the proportion of relevant synonyms for each search term (step S64), applying a recall query based on the two or more search terms to run a second concept search of remaining ones of the collection of documents which were not returned by the first Boolean search, the second search returning a second subset of potentially relevant documents in the collection (step S65), calculating the probability that each search result in the recall query is relevant to a given topic based upon an ordering of the concept search results by relevance to the topic by vector analysis (step S66), accumulating all search results that have a relevancy probability of greater than 50% into a subset of the collection (step S67), randomly selecting a predetermined number of documents from the remaining subset of the collection and determining whether the randomly selected documents include additional relevant documents (step S68), if additional relevant documents are found (step S69, yes), identifying the specific language that causes relevancy, and expanding that language into a set of queries (step S70), constructing and running precision Boolean queries of the entire document collection above (step S71).

The following discussions of theory and exemplary embodiments are set forth to aid in an understanding of the subject matter of this disclosure but are not intended to, and should not be construed as, limiting in any way the invention as set forth in the claims which follow thereafter.

As discussed above, one of the problems with using conventional search engine techniques in culling a collection of content data or documents is that such techniques do not meet the requirements of recall and precision.

However, by using statistical sampling techniques it is possible to state with a defined degree of confidence the percentage of relevant documents that may have been missed. Assuming the percentage missed is set low enough (1%) and the confidence level is set high enough (99%), this statistical approach to identifying relevant documents would likely satisfy most judges in most jurisdictions. The problem then becomes how to select a subset of the document collection that is likely to contain all responsive documents. Failure to select accurate content data in the first place results in an endless cycle of statistical testing.

The probability that results from a simple Boolean search (word search) is relevant to a given topic and is directly related to the probability that the query terms themselves are relevant, i.e. that those terms are used within a relevant definition or context in the documents. Similarly, the likelihood that a complex Boolean query will return relevant documents is a function of the probability that the query terms themselves are relevant.

For example, the documents collected for review in today's lawsuits contain an enormous amount of email. It has been found that corporate email is not at all restricted to “business as such” usage. In fact, it is hard to distinguish between personal and business email accounts based on subject matter. As a consequence, even though a particular word may have a particular meaning within an industry, the occurrence of that word in an email found on a company server does not guarantee that is it has been used in association with its “business” definition.

An exemplary method for determining a probability of relevancy to a defined context is discussed below.

The following factors can be used to determine the probability that a word has been used in the defined context within a document: (1) the number of possible definitions of the word as compared to the number of relevant definitions; and (2) the relative obscurity of relevant definitions as compared to other definitions.

Calculation of the first factor is straightforward. If a word has five potential definitions (as determined by a credible dictionary) and if one of those definitions is responsive, then the basic probability that word is used responsively in any document retrieved during discovery is 20% (⅕). This calculation assumes, however, that all definitions are equally common, that they are all equally likely to be chosen by a writer describing the subject matter. Of course, that is generally not the case; some definitions are more “obscure” than others meaning that users are less likely to chose the word to impart that meaning. Thus, a measure of obscurity must be factored into the probability calculation.

A social networking approach can be taken to measure obscurity. The following method is consistent with the procedure generally used in the legal field currently for constructing query lists: (i) a list of potential query terms (keywords) is developed by the attorney team; (ii) for each word, a corresponding list of synonyms is created using a thesaurus; (iii) social network is drawn (using software) between all synonyms and keywords; (iv) a count of the number of ties at each node in the network is taken (each word is a node); (v) an obscurity factor is determined as the ratio between the number of ties at any word node and the greatest number of ties at any word node, or alternatively their respective z scores; and (vi) this obscurity factor is applied to the definitional probability calculated above.

The method described above calculates the probability that a given word is used in a relevant manner in a document. Boolean queries usually consist of multiple words, and thus a method of calculating the query terms interacting with each other is required.

The simplest complex queries consist of query terms separated by the Boolean operators AND and/or OR. For queries separated by an AND operator, the individual probabilities of each word in the query are multiplied together to yield the probability that the complex query will return responsive results. For query terms separated by an OR operator, the probability of the query yielding relevant results is equal to the probability of the lowest ranked search term in the query string.

Query words strung together within quotation marks are typically treated as a single phrase in Boolean engines (i.e. they are treated as if the string is one word). A document is returned as a result if and only if the entire phrase exists within the document. For purposes of calculating probability, the phrase is translated to its closest synonym and the probability of that word is assigned to the phrase. Moreover, since a phrase generally has a defined part of speech (noun, verb, adjective, etc.), when calculating probability one considers only the total number of possible definitions for that part of speech, thereby reducing the denominator of the equation and increasing the probability of a responsive result.

Complex Boolean queries can take the form of “A within X words B”, where A and B are query terms and X is the number of words in separating them in a document which is usually a small number. The purpose of this type of query, called a proximity query, is to define the terms in relation to one another. This increases the probability that the words will be used responsively. The probability that a proximity query will return responsive documents equals the probability of the highest query term in the query will be responsive.

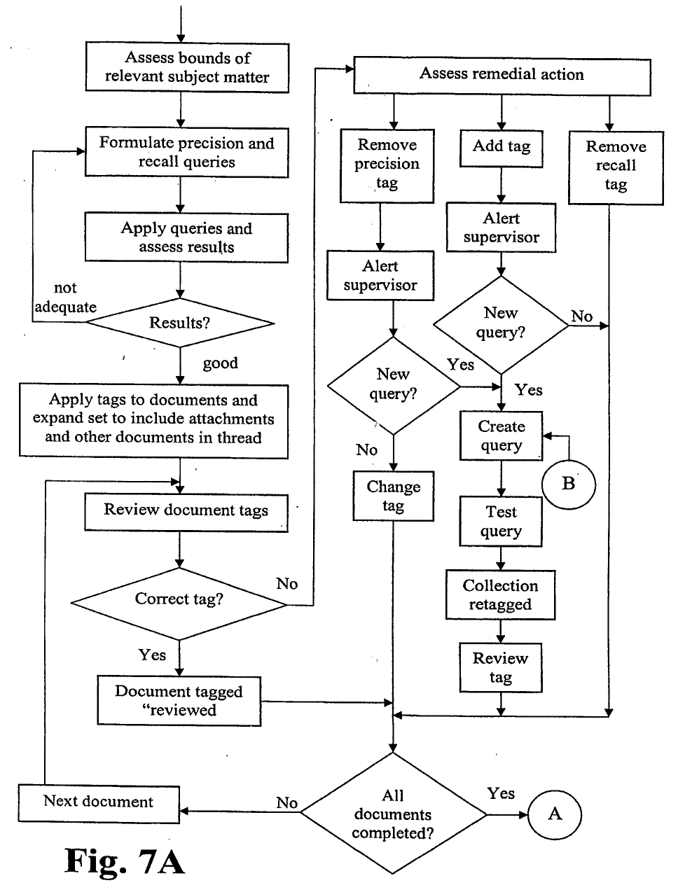

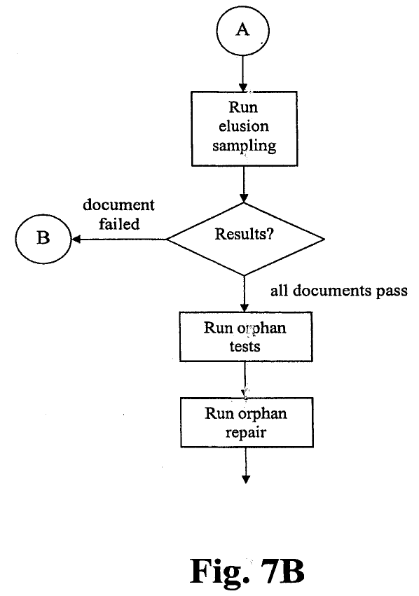

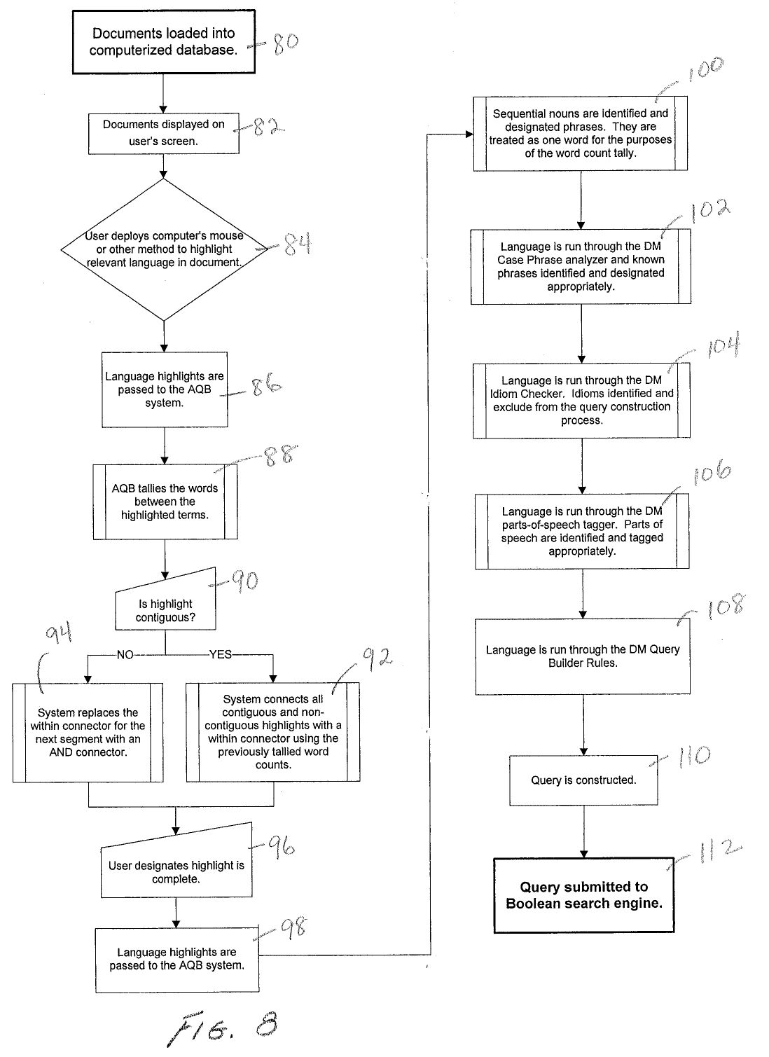

A workflow of a process including application of some of the techniques discussed herein, according to one example, is shown exemplarily in FIGS. 7A and 7B.

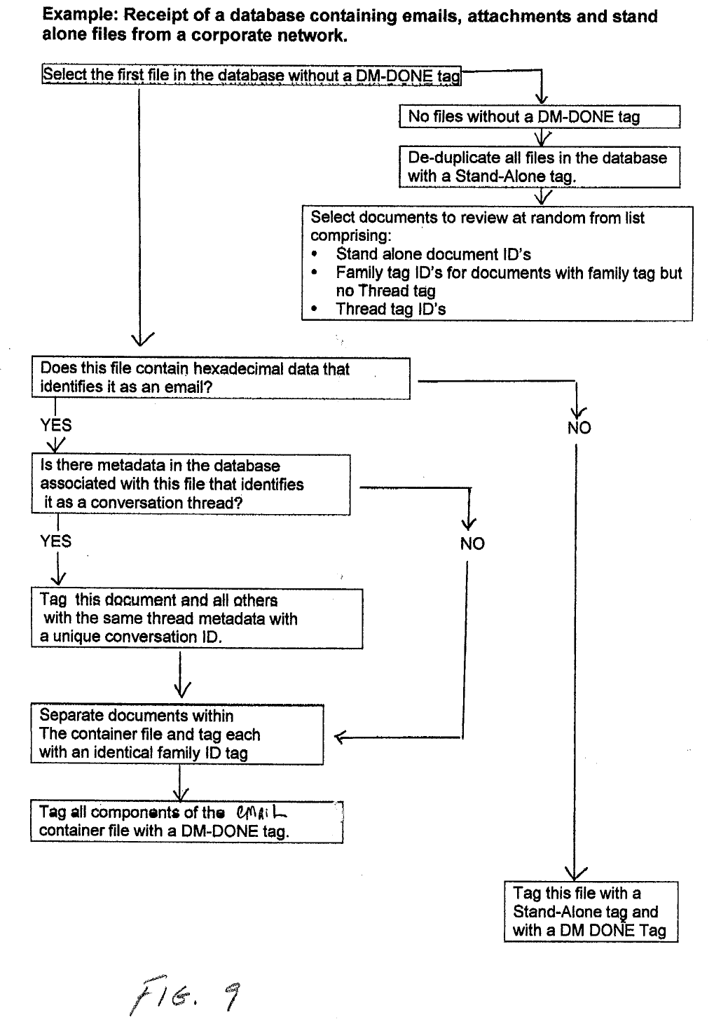

FIG. 8 is a flow chart of the automated query builder feature of the present system and method. This aspect includes operations whereby content data or documents are loaded into a database, illustrated by block 80. The content data or documents may be displayed on the user's screen (shown at 82). The user may use a computer mouse or other method to highlight the relevant text in the content data or document, as illustrated by reference numeral 84. The highlighted text is forwarded to the automatic query builder routine in the system (see block 86). As illustrated by block 88, the automatic query builder routine tallies the words between the highlighted terms. The system ensures that the highlighting is contiguous (see 90). If it is, the system connects all contiguous and non-contiguous highlights within a connector using the previously tallied word counts (see block 92). If it is not, the system replaces the within connector for the next segment with an AND connector (see 94). Following these operations, the user designates that the highlighting is complete (see 96). The highlighted section is passed to the automatic query builder, at 98.

The automatic query builder identifies sequential nouns and designated phrases. These are treated as a single word for the purpose of the word count tally (indicated by reference numeral 100). Following this operation, the text is run through the case phrase analyzer, where known phrases are identified and appropriately designated (see 102). The language is run through the idiom checker (see 104) where idioms are identified and excluded from the query construction process. After this operation, the text is run through a parts-of-speech tagger routine (106). This routine identifies parts of speech and appropriately tags them. Finally, the text is run through the system query builder rules (shown at 108) and a query is constructed (see step 110). Once a query is constructed, the system submits the query to the Boolean search engine at 112.

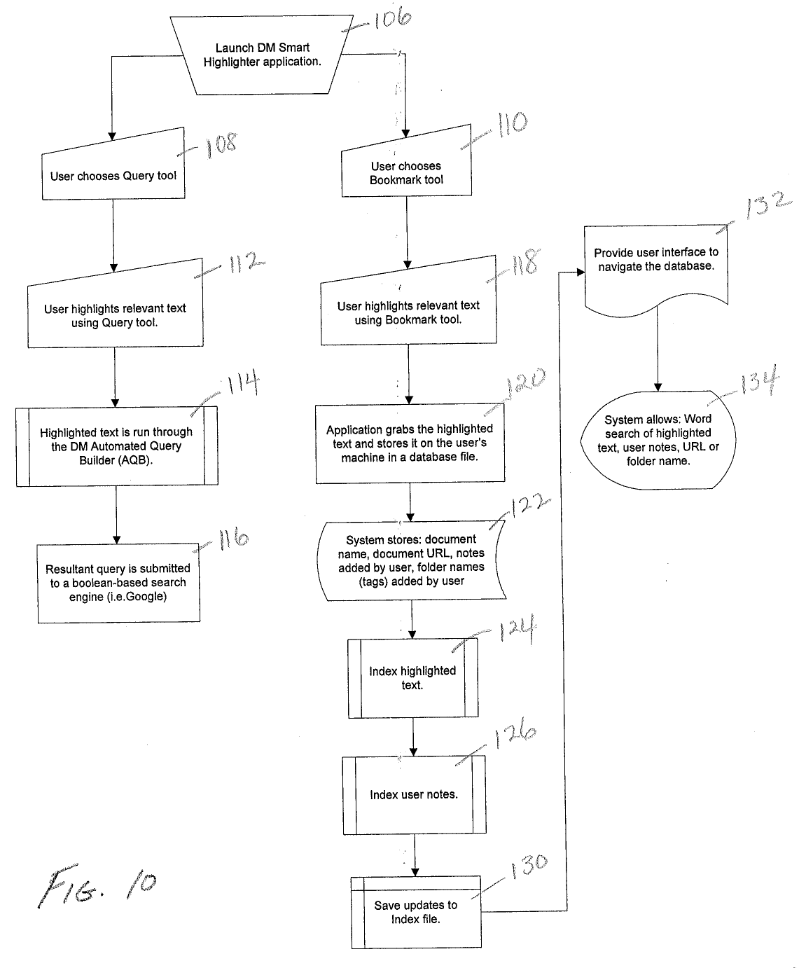

FIG. 9 illustrates the way related content data is identified and ultimately tagged. For example, in a database of a corporate network containing emails, attachments and stand alone files, the system considers all content data in a thread of correspondence (for example, an e-mail) and includes it in the subset of relevant data. The system also scans the content data in the thread and automatically identifies other data of interest, for example, contained in attachments and includes that as well.

FIG. 10 illustrates a flow chart representing the steps used in a “smart highlighter” routine of the system. This routine is launched (106) allowing the user to select either a query tool (see 108) or a bookmark tool (see 110). In the event the user chooses a query tool, the user can use it to highlight any text of interest (see 112). The highlighted text is run through an automated query builder (see 114) and the resulting query is submitted to the Boolean-based search engine (116).

In the event the user chooses the bookmark tool, the user highlights any text of interest with the bookmark tool (see 118). The system takes the highlighted text and stores it on the user's computer machine in a database file (see 120). At operation 122, the system stores the document name, document URL, any notes added by the user, folder names (tags) added by the user. Following this, the system indexes the highlighted text (124), the user notes (126) and saves updates to the index file (130). The user may navigate the database via a user interface (132) as the system allows a word search of the highlighted text, user notes, URL or folder name etc. (134).

The specific embodiments and examples described herein are illustrative, and many variations can be introduced on these embodiments and examples without departing from the spirit of the disclosure or from the scope of the appended claims. For example, features of different illustrative embodiments and examples may be combined with each other and/or substituted for each other within the scope of this disclosure and appended claims.

### REFERENCES

Herbert L. Roitblat, “Electronic Data Are Increasingly Important To Successful Litigation” (November 2004).
Herbert L. Roitblat, “Document Retrieval” (2005).
“The Sedona Principles: Best Practices Recommendations & Principles for Addressing Electronic Document Production” (July 2005 Version).

What is claimed is:

1. A method for searching through vast amounts of content data to identify relevant content data, the method comprising the steps of:
executing a search routine based on one or more query terms constructed by an automated routine including highlighting and bookmarking techniques to retrieve a subset of responsive content data;
determining a corresponding probability of relevancy for each unit of content data in the responsive content data; and
removing from the responsive content data, one or more units of content data that do not reach a threshold probability of relevancy.
